(19) United States
(12) Patent Application Publication
(10) Pub. No.: US 2008/0263823 A1
(43) Pub. Date: Oct. 30, 2008

(54) Hinge assembly

(75) Inventor: Chung-Yu Lee, Shulin City (TW)

Correspondence Address: COOPER & DUNHAM, LLP, 1185 AVENUE OF THE AMERICAS, NEW YORK, NY, 10036, US

(73) Assignee: Shin Zu Shing Co., Ltd.

(21) Appl. No.: 11/789,141

(22) Filed: Apr. 24, 2007

(51) Int. Cl. E05F 1/08

(52) U.S. Cl. 16/277

(57) ABSTRACT

A hinge assembly is used to pivotally attach a cover to a base of an electronic device and has a stationary leaf, at least one barrel and a pintle assembly. The stationary leaf has an upper end and barrel housing. The barrel housing has a slot and two keyways. Each barrel is mounted in the barrel housing and has a neck and two keys. The neck has two sides. The two keys are formed respectively on the two sides of the neck and are mounted respectively in the keyways. The pintle assembly is mounted through the bushing of the at least one barrel.

### BACKGROUND OF THE INVENTION

1. Field of the Invention

The present invention relates to a hinge, and more particularly to a hinge that is not susceptible to fatigue failure.

2. Description of the Prior Art

Electronic devices such as: laptops, mobile phones, personal digital assistants (PDA), etc. have a base, a cover and a hinge. The hinge pivotally connects the cover to the base.

With reference to FIG. 7, a conventional hinge assembly comprises a leaf (70), at least one barrel (80) and a pintle assembly (90).

The leaf (70) connects to the base of an electronic device and has a mounting hole (71) and a slot (72). The mounting hole (71) is formed transversely through the leaf (70). The slot (72) is also formed transversely through the leaf (70), communicates with the mounting hole (71) and has two side surfaces, a top and two keyways (721). The keyways (721) are formed in the two side surfaces of the slot (72).

Each barrel (80) has a bushing (83), a neck (81) and a fastening protrusion (82). The neck (81) has a proximal end and two side surfaces. The fastening protrusion (82) is formed on one of the two side surfaces of the neck (81). The at least one barrel (80) is mounted in the leaf (70). The bushing (83) is mounted in the mounting hole (71), the neck (81) is mounted in the slot (72) and the fastening protrusion (82) is mounted in one of the two keyways (721) of the slot (72).

The pintle assembly (90) connects to the cover of the electronic device and has a pintle (91). The pintle (91) is mounted through the bushing (83) of the at least one barrel (80) allowing the cover to pivot relative to the base and set the cover at any angle.

However, since each of the at least one barrel (80) is mounted in the leaf (70) with only the top of the slot (72) abutting the bushing (83) and the fastening protrusion (82) abutting the keyways (721), the at least one barrel (80) may not be properly mounted in the leaf (70) and can break away from the leaf (70).

To overcome the shortcomings, the present invention provides a hinge assembly to mitigate or obviate the aforementioned problems.

### SUMMARY OF THE INVENTION

The main objective of the present invention is to provide a hinge assembly that is used to pivotally attach a cover to a base of an electronic device and has a barrel that is less susceptible to failure.

The hinge assembly in accordance with the present invention has a stationary leaf, at least one barrel and a pintle assembly. The stationary leaf has an upper end and barrel housing. The barrel housing has a slot and two keyways. Each barrel is mounted in the barrel housing and has a neck and two keys. The neck has two sides. The two keys are formed respectively on the two sides of the neck and are mounted respectively in the keyways. The pintle assembly is mounted through the bushing of the at least one barrel.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a hinge assembly in accordance with the present invention;

FIG. 2 is a side view in partial section of the hinge assembly in FIG. 1;

FIG. 3 is a front view of the hinge assembly in FIG. 1;

FIG. 4 is a front view in partial section of the hinge assembly in FIG. 1 with the pintle in the bushing;

FIG. 5 is a front view of the hinge assembly in FIG. 1;

FIG. 6 is an exploded perspective view of a second embodiment of a hinge assembly in accordance with the present invention; and

FIG. 7 is an exploded perspective view of a conventional hinge assembly in accordance with the prior art.

### DETAILED DESCRIPTION OF THE PREFERRED EMBODIMENTS

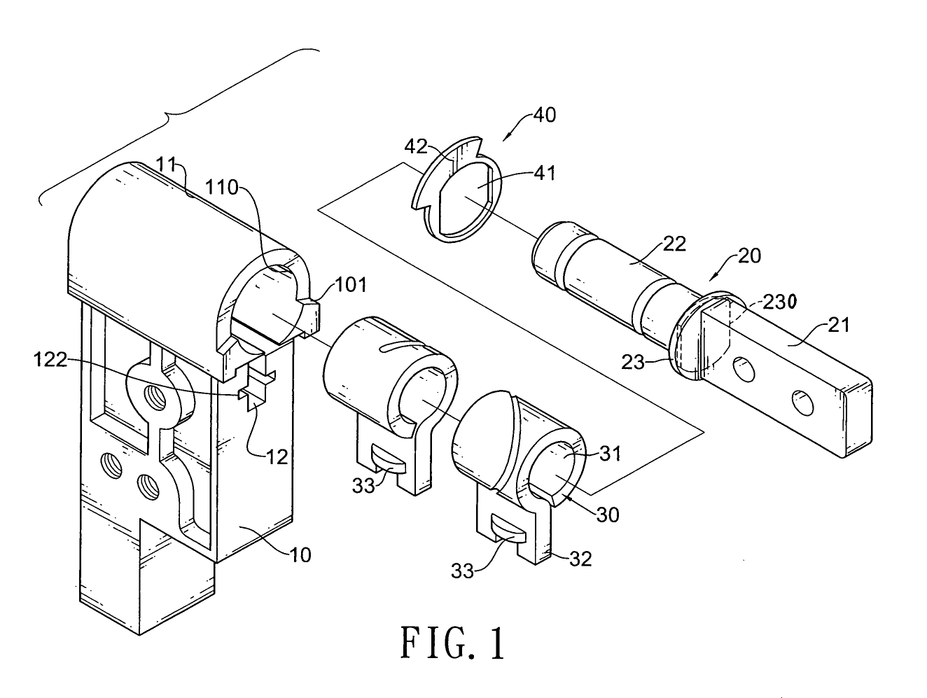

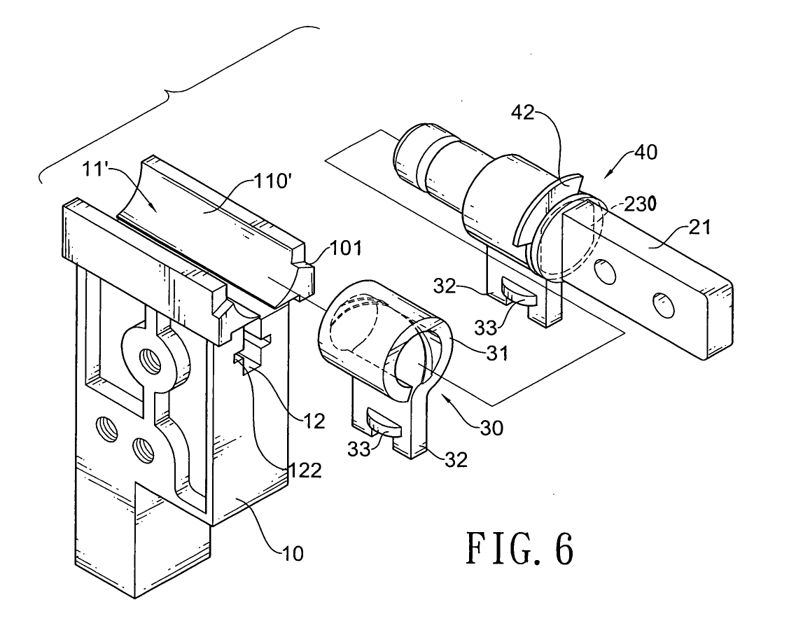

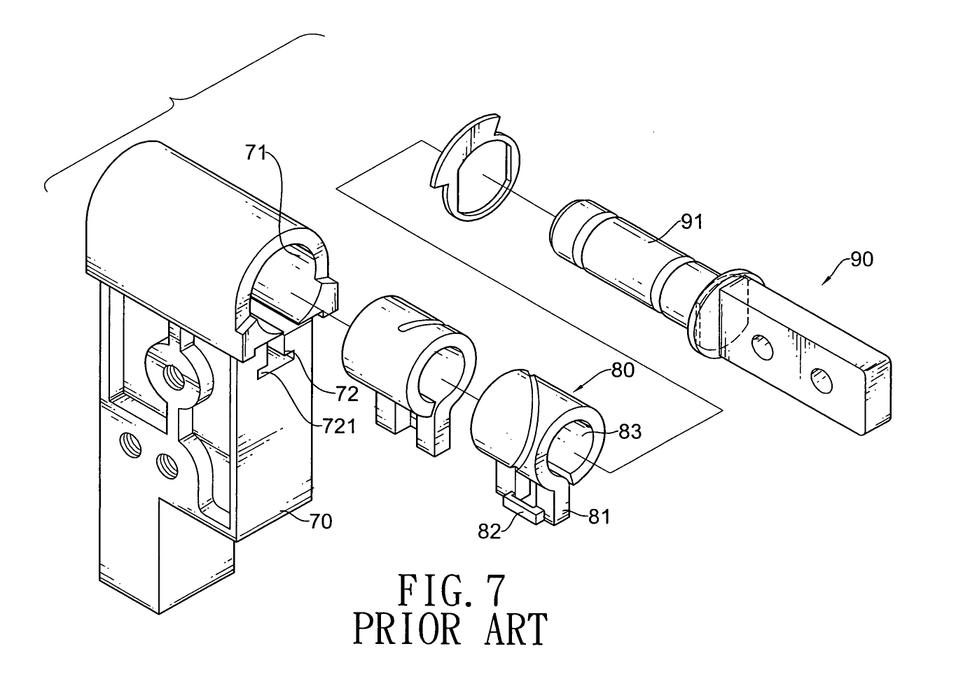

With reference to FIGS. 1 and 6, the hinge assembly in accordance with the present invention is used to pivotally attach a cover to a base of an electronic device and has a stationary leaf (10), at least one barrel (30), an optional limit (40) and a pintle assembly (20).

The stationary leaf (10) connects to the base of the electronic device and has an upper end and a barrel housing (11, 11′). The barrel housing (11, 11′) is formed longitudinally on the upper end of the stationary leaf (10), may be implemented with a mounting hole (110) or a mounting recess (110′) and has a front end, a mounting slot (12) and two optional positive stops (101).

The mounting hole (110) is formed in the barrel housing (11).

The mounting recess (110′) is formed in the barrel housing (11′) and may be semi-cylindrical.

The mounting slot (12) is formed in the upper end of the stationary leaf (10), communicates with the mounting hole (110) or the mounting recess (110′) and has a top, two side surfaces and two keyways (122). The top communicates with the mounting hole (110) or the mounting recess (110′). The two keyways (122) are formed longitudinally respectively in the two side surfaces of the mounting slot (12).

The two positive stops (101) are formed on the front end of the barrel housing (11, 11′).

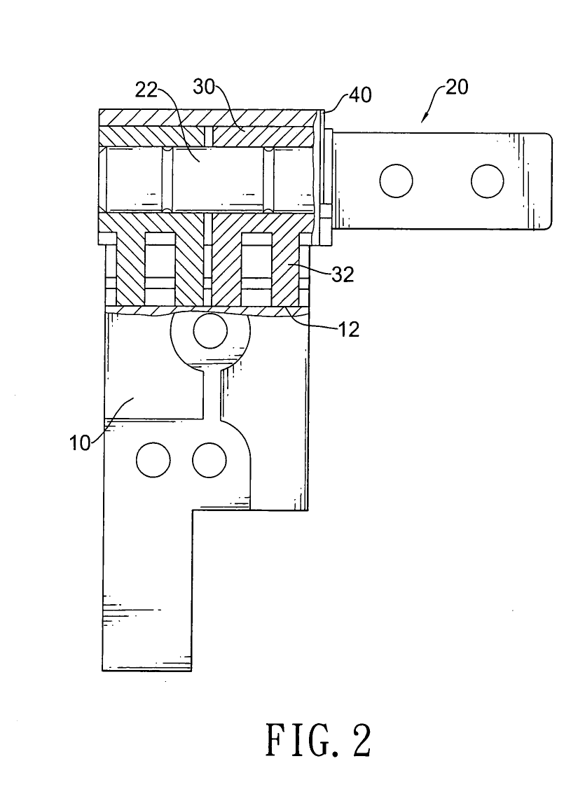

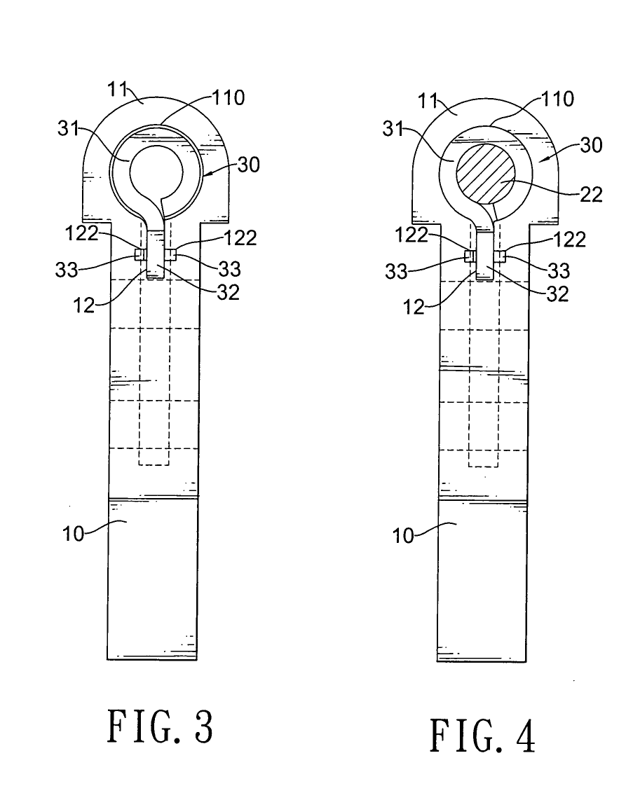

With further reference to FIGS. 2 to 4, each barrel (30) is mounted in the barrel housing (11, 11′) and has a bushing (31), a neck (32) and two keys (33). The bushing (31) is a resilient slotted cylinder, is mounted in the barrel housing (11, 11′) and has an outer surface and a longitudinal slot. The neck (32) is formed longitudinally on and protrudes out from the outer surface of the bushing (31) adjacent to the longitudinal slot, is mounted in the mounting slot (12) and has two sides. The keys (33) are formed respectively on the two sides of the neck (32), are mounted respectively in the keyways (122) in the mounting slot (12) and hold the barrel (30) securely on the stationary leaf (10).

The pintle assembly (20) is mounted rotatably in the at least one barrel (30), connects to the cover of the electronic device and has an inner end, an outer end, a pivoting leaf (21), a pintle (22) and a lip (23).

The pivoting leaf (21) is attached securely to the cover of the electronic device and has a proximal end.

The pintle (22) is formed on and protrudes longitudinally from the proximal end of the pivoting leaf (21), may be larger than the bushing (31) of each barrel (30), expands the bushing (31) of each of the at least one barrels (30) when the pintle (22) is mounted in the bushing (31), holds the pintle assembly (20) tightly in the barrel housing (11, 11′) and has an outer end.

The lip (23) keeps the pintle (22) from sliding completely into the bushing (31), is formed on and protrudes out from the outer end of the pintle (22), has an inner surface and may have a key (230). The key (230) may be a non-circular protrusion or recess formed on the inner surface of the lip (23).

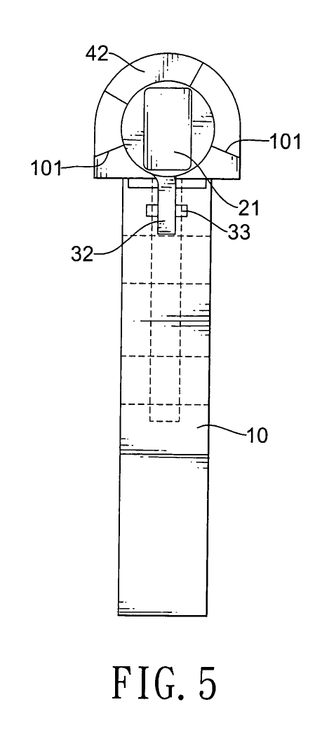

With further reference to FIG. 5, the limit (40) keeps the pintle assembly (20) from rotating excessively, is mounted securely on the inner surface of the lip (23) and slidably against the front end of the barrel housing (11, 11′) and has an outer edge, a central hole (41) and a protruding stop (42). The central hole (41) is formed through the limit (40), corresponds to the key (230) on the lip (23) and is mounted securely on the lip (23). The protruding stop (42) is formed on and protrudes out from the outer edge of the limit (40) and has two radial edges. The radial edges slide between and selectively abut the two positive stops (101) to stop rotation of the pintle assembly (20).

The hinge assembly as described has the following advantages. Each of the at least one barrel (30) is mounted in the barrel housing (11, 11′) with the neck (32) mounted in the mounting slot (12). The two keys (33) on the neck (32) are mounted respectively in the two keyways (122) to securely hold the barrel (30) in place. With these three interfaces, the pintle assembly (20), the barrel (30) and the stationary leaf (10) are held firmly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge assembly having
a stationary leaf having
an upper end; and
a barrel housing being formed longitudinally on the upper end of the stationary leaf and having
a front end; and
a mounting slot being formed in the upper end of the stationary leaf and having
a top;
two side surfaces; and
two keyways being formed longitudinally respectively in the two side surfaces;
at least one barrel being mounted in the barrel housing, and each one of the at least one barrel having
a bushing being a resilient slotted cylinder, being mounted in the barrel housing and having
an outer surface; and
a longitudinal slot;
a neck being formed longitudinally on and protruding out from the outer surface of the bushing adjacent to the longitudinal slot, being mounted in the mounting slot and having two sides; and
two keys being formed respectively on the two sides of the neck, being mounted respectively in the two keyways and holding the barrel securely on the stationary leaf; and a pintle assembly being mounted rotatably in the at least one barrel and having
an inner end;
an outer end;
a pivoting leaf having a proximal end;
a pintle being formed on and protruding longitudinally from the proximal end of the pivoting leaf and having an outer end; and
a lip keeping the pintle from sliding completely into the bushing, being formed on and protruding out from the outer end of the pintle and having an inner surface.

2. The hinge assembly as claimed in claim 1, wherein
the barrel housing is implemented with a mounting hole being formed in the barrel housing; and
the top of the mounting slot communicates with the mounting hole.

3. The hinge assembly as claimed in claim 1, wherein the barrel housing is implemented as a mounting recess formed in the barrel housing; and
the top of the mounting slot communicates with the mounting recess.

4. The hinge assembly as claimed in claim 1, wherein the pintle larger than the bushing of each one of the at least one barrel, expands the bushing of the at least one barrel and holds the pintle assembly tightly in the barrel housing.

5. The hinge assembly as claimed in claim 2, wherein
the barrel housing further has two positive stops formed on the front end;
the lip further has a key; and
the hinge assembly further has a limit keeping the pintle assembly from rotating excessively, corresponding to and being mounted securely on the inner surface of the lip and slidably against the front end of the barrel housing and having
an outer edge;
a central hole formed through the limit and mounted securely on the lip; and
a protruding stop formed on and protruding out from the outer edge of the limit and having two radial edges sliding between and selectively abutting the two positive stops.

6. The hinge assembly as claimed in claim 3, wherein
the barrel housing further has two positive stops formed on the front end;
the lip further has a key; and
the hinge assembly further has a limit keeping the pintle assembly from rotating excessively, corresponding to and being mounted securely on the inner surface of the lip and slidably against the front end of the barrel housing and having
an outer edge;
a central hole formed through the limit and mounted securely on the lip; and
a protruding stop formed on and protruding out from the outer edge of the limit and having two radial edges sliding between and selectively abutting the two positive stops.

7. The hinge assembly as claimed in claim 3, wherein the mounting recess is semi-cylindrical.

8. The hinge assembly as claimed in claim 5, wherein the key on the lip is a non-circular protrusion.

9. The hinge assembly as claimed in claim 6, wherein the key on the lip is a non-circular protrusion.
